(19) United States
(12) Patent Application Publication
(10) Pub. No.: US 2013/0235120 A1
(43) Pub. Date: Sep. 12, 2013

(54) STRUCTURE BODY HAVING LIQUID-REPELLENT SURFACE, NOZZLE PLATE OF INKJET HEAD, AND METHOD OF CLEANING STRUCTURE BODY AND NOZZLE PLATE

(71) Applicants: Yasutoshi HIRABAYASHI, Kanagawa (JP); Hideki YASUDA, Kanagawa (JP); Yuichi TOMARU, Kanagawa (JP)

(72) Inventors: Yasutoshi HIRABAYASHI, Kanagawa (JP); Hideki YASUDA, Kanagawa (JP); Yuichi TOMARU, Kanagawa (JP)

(73) Assignee: FUJIFILM CORPORATION, Tokyo (JP)

(21) Appl. No.: 13/602,152

(22) Filed: Sep. 1, 2012

(30) Foreign Application Priority Data
Sep. 1, 2011 (JP) 2011-190874

(51) Int. Cl. B41J 2/14

(52) U.S. Cl. CPC B41J 2/1433
USPC 347/22; 347/45

(57) ABSTRACT

A structure body has a liquid-repellent surface exhibiting repellency to a liquid. The structure body includes: a substrate which has a base surface; and a plurality of projections which are arranged on the base surface of the substrate. The projections have a characteristic angle defined as an angle between a lateral surface of each of the projections and a plane that intersects with the lateral surface and is parallel to the base surface, the angle being taken inside the projection on the lateral surface and in a side of the base surface on the plane. The characteristic angle of the projections is smaller than 90° and is smaller than a reference angle that is separately determined as a static contact angle of the liquid with respect to a reference surface that is smooth and has a chemical state identical to a chemical state of the lateral surface of the projection.

### BACKGROUND OF THE INVENTION

1. Field of the Invention

The present invention relates to a structure body having a liquid-repellent surface, a nozzle plate of an inkjet head, and a method of cleaning the structure body and the nozzle plate, and more particularly to a super-liquid-repellent surface having a roughness structure exhibiting excellent droplet roll-off properties.

2. Description of the Related Art

Technology is known for imparting liquid-repellent properties on solid surfaces by a chemical treatment, such as coating with fluorine resin or silicone resin, and the like. On the other hand, it is also known that the liquid-repellent properties of solid surfaces can be changed by structural processing, such as formation of a roughness structure, and by this method it is possible to achieve a high contact angle which cannot be achieved by chemical treatment alone. In particular, surfaces exhibiting contact angles of not smaller than 150° are referred to as super-hydrophobic surfaces or super-liquid-repellent surfaces.

Japanese Patent Application Publication No. 07-197017 describes a solid having a liquid-repellent surface formed to a fractal structure with the surface area multiplication factor of 5 or higher, using alkylketane dimer and dialkyl ketone as material of low surface tension.

Japanese Patent Application Publication No. 2006-182014 describes a liquid-repellent enhancing structure which is capable of increasing the contact angle even with a liquid having the contact angle of not larger than 90° on a smooth surface, by making the inner walls of cavities formed on a substrate substantially parallel with the thickness direction of the substrate (α<126°) to cause air bubbles to fill the cavities under the droplets.

“Designing Superoleophobic Surfaces” (Anish Tuteja, et. al., Science 318, 1618 (2007)) describes employing a re-entrant structure to enable the imparting of high liquid-repellent properties even in respect of a liquid having the contact angle of not larger than 90° (e.g., octane) on a smooth surface.

### SUMMARY OF THE INVENTION

In recent years, in various engineering fields, such as construction and transport machinery, on top of the static liquid-repellent properties, a capability for easily removing adhering droplets has also been demanded, and hence dynamic liquid-repellent properties such as droplet roll-off properties have been sought. In the case of inkjet technology also, it is necessary to remove ink adhering to nozzle faces, and the dynamic liquid-repellent properties are important parameters.

The structure described in Japanese Patent Application Publication No. 07-197017 is directed to a liquid having the contact angle of not smaller than 90° on a smooth surface, and has not been used to achieve the liquid-repellent properties in respect of a liquid having the contact angle smaller than 90° on the smooth surface. Moreover, no investigation has been made in respect of the droplet roll-off properties. Japanese Patent Application Publication No. 2006-182014 does not investigate the droplet roll-off properties, either.

With regard to the surface structure described in “Designing Superoleophobic Surfaces”, although no direct reference is made to the droplet roll-off properties, the contact angle hysteresis, which is the difference between the advancing and receding contact angles and is an indicator of the droplet roll-off properties, is extremely low and the structure is thought to have high droplet roll-off properties. However, the droplets may enter the cavities, in cases where the droplet size is similar to or smaller than the size of gap between the projections, or in cases where an external force of any kind acts on the droplets. If the liquid enters the cavities, then the super-liquid-repellent properties are lost, and in the case of the re-entrant structure, it is difficult to remove the droplets inside the cavities. In particular, in a case where the structure is used in a nozzle plate of an inkjet head, ink mist may readily enter the cavities and therefore the liquid-repellent properties and the droplet roll-off properties are liable to deteriorate, and these properties cannot be restored readily.

The present invention has been contrived in view of these circumstances, an object thereof being to provide a structure body having a liquid-repellent surface and a nozzle plate of an inkjet head including the structure body, which have excellent liquid-repellent properties and droplet roll-off properties, and which can be restored by cleaning in the event of loss of the high liquid-repellent properties and droplet roll-off properties, and to provide methods of cleaning the structure body and the nozzle plate.

In order to attain the aforementioned object, the present invention is directed to a structure body having a liquid-repellent surface exhibiting repellency to a liquid, the structure body comprising: a substrate which has a base surface; and a plurality of projections which are arranged on the base surface of the substrate, wherein: the projections have a characteristic angle defined as an angle between a lateral surface of each of the projections and a plane that intersects with the lateral surface and is parallel to the base surface, the angle being taken inside the projection on the lateral surface and in a side of the base surface on the plane; and the characteristic angle of the projections is smaller than 90° and is smaller than a reference angle that is separately determined as a static contact angle of the liquid with respect to a reference surface that is smooth and has a chemical state identical to a chemical state of the lateral surface of each of the projections.

According to this aspect of the present invention, the characteristic angle of the projections, which is defined as the angle between the lateral surface of each of the projections and the plane that intersects with the lateral surface and is parallel to the base surface, the angle being taken inside the projection on the lateral surface and in a side of the base surface on the plane, is smaller than 90°, in other words, the projections have an inverted tapered shape. Moreover, the characteristic angle is smaller than the reference angle that is separately determined as the static contact angle of the liquid with respect to the reference surface that is smooth and has the chemical state identical to the chemical state of the lateral surface of each of the projections. Consequently, when the liquid droplet is deposited on the structure body, the shapes of the liquid surfaces inside the recesses can be made convex toward the inside of the recesses. Therefore, the liquid can be expelled from the recesses by the Laplace pressure, and the liquid-repellent properties can be obtained. Furthermore, since the contact area between the liquid and the liquid-repellent surface can be reduced, then it is possible to reduce the adhesion energy, and the liquid can be removed with a small roll-off angle.

Here, “the static contact angle of the liquid on the smooth surface” means the static contact angle of the liquid measured on a smooth surface having a roughness average (Ra) of not more than 5 nm.

Preferably, the projections have top surfaces which are parallel to the base surface and have a uniform height from the base surface.

According to this aspect of the present invention, since the top surfaces of the projections are formed in parallel with the substrate and the projections are formed to uniform height, then it is possible to impart uniform liquid-repellent properties to the liquid-repellent surface of the substrate. Here, “the top surfaces of the projections” mean the surfaces of the projections on the opposite side from the substrate.

Preferably, a ratio of a total area of top surfaces of the projections with respect to a total area of the base surface is not higher than 0.4.

According to this aspect of the present invention, the area ratio of the top surfaces of the projections is not higher than 0.4 with respect to the total base surface, and therefore it is possible to reduce the contact area between the liquid and the liquid-repellent surface. Consequently, it is possible to reduce the adhesion energy, and hence the droplet roll-off properties can be improved and even small droplets can be rolled off.

Preferably, the structure body further comprises a liquid-repellent coating which covers the base surface and the projections.

According to this aspect of the present invention, since the liquid-repellent coating is formed over the liquid-repellent surface, then it is possible to increase the contact angle of the droplets on the smooth surface. Consequently, even in the case of droplets having a small surface tension, it is possible to increase the contact angle, and therefore the types of usable liquids can be increased.

Preferably, a roll-off angle of a 10 μl water droplet on the liquid-repellent coating is not larger than 40°.

According to this aspect of the present invention, by setting the roll-off properties to the conditions described above, then the liquid adhering to the liquid-repellent surface can be removed easily.

Preferably, the liquid-repellent coating is composed of perfluoroalkyl silane containing oxygen.

According to this aspect of the present invention, by using perfluoroalkyl silane containing oxygen as the material for the liquid-repellent coating, it is possible to form the liquid-repellent coating having good roll-off properties.

In order to attain the aforementioned object, the present invention is also directed to a method of cleaning the structure body, the method comprising the steps of: cleaning the structure body with a cleaning liquid having a static contact angle with respect to the reference surface that is smaller than the characteristic angle of the projections; and then substituting the cleaning liquid remaining on the structure body with a substituting liquid having a static contact angle with respect to the reference surface that is larger than the characteristic angle of the projections.

According to this aspect of the present invention, firstly, the structure body is cleaned with the cleaning liquid that has the static contact angle with respect to the reference surface that is smaller than the characteristic angle of the projections. By using the cleaning liquid that has the static contact angle smaller than the characteristic angle of the projections, it is possible to make the cleaning liquid enter readily inside the recesses between the projections, and therefore the cleaning can be performed easily. Thereupon, the substitution of the cleaning liquid remaining inside the recesses is carried out with the substituting liquid having the static contact angle with respect to the reference surface that is larger than the characteristic angle of the projections. By using the substituting liquid having the static contact angle larger than the characteristic angle of the projections, the force acts on the substituting liquid inside the recesses to expel the substituting liquid from the recesses, and therefore the substituting liquid inside the recesses is caused to move out from the recesses. Consequently, since the liquids are prevented from remaining inside the recesses after the end of the substituting step, it is possible to restore the liquid-repellent surface.

In order to attain the aforementioned object, the present invention is also directed to a nozzle plate of an inkjet head comprising the structure body.

The structure body having the liquid-repellent surface described above can be used satisfactorily as the nozzle plate of the inkjet head.

Preferably, the projections are arranged only in regions distanced from nozzles by at least 10 μm.

According to this aspect of the present invention, the projections are formed in the regions distanced by at least 10 μm from the nozzles, and are not formed in the periphery of the nozzles. Consequently, it is possible to prevent deflection of ejection from the nozzles which occurs in the case of asymmetrical nozzle shapes as a result of alignment errors during formation of the nozzles.

In order to attain the aforementioned object, the present invention is also directed to a method of cleaning the nozzle plate, the method comprising the steps of: cleaning the nozzle plate with a cleaning liquid having a static contact angle with respect to the reference surface that is smaller than the characteristic angle of the projections; and then substituting the cleaning liquid remaining on the nozzle plate with a substituting liquid having a static contact angle with respect to the reference surface that is larger than the characteristic angle of the projections.

According to this aspect of the present invention, similarly to the cleaning method for the structure body described above, it is possible to cause the cleaning liquid and the substituting liquid to enter and leave the recesses readily, by using the Laplace pressure, and therefore the cleaning of the insides of the recesses can be performed easily.

According to the structure body having the liquid-repellent surface, the cleaning method for the structure body, the nozzle plate of the inkjet head, the cleaning method for the nozzle plate of the present invention, it is possible to achieve the liquid-repellent surface having excellent droplet roll-off properties, and furthermore, the cleaning properties can also be improved.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic drawing showing a Wenzel model;

FIG. 2 is a schematic drawing showing a Cassie-Baxter model;

FIGS. 3A and 3B are diagrams for describing capillary actions;

FIG. 4 is a diagram for illustrating relationships between the contact angles of the liquids and the characteristic angles of projections;

FIGS. 5A to 5D are diagrams for describing a method of forming the roughness structure on a substrate;

FIG. 6 is a plan diagram showing one example of a structure body having a liquid-repellent surface with the roughness structure;

FIGS. 7A to 7C are diagrams showing cross-sections of the structure bodies having the liquid-repellent surfaces with the roughness structures;

FIG. 8 is a general schematic drawing showing an inkjet recording apparatus;

FIGS. 9A and 9B are plan view perspective diagrams showing examples of the structures of inkjet heads;

FIG. 10 is a cross-sectional diagram along line 10-10 in FIG. 9A;

FIG. 11 is a plan view diagram showing an example of a nozzle plate surface;

FIGS. 12A and 12B are diagrams illustrating problems in a case where there is no first liquid-repellent region;

FIGS. 13A and 13B are views of a liquid-repellent surface before and after cleaning in a comparative example;

FIGS. 14A and 14B are views of a liquid-repellent surface before and after cleaning in a practical example of the present invention; and

FIG. 15 is a graph showing a relationship between a ratio of projections and a roll-off angle.

### DETAILED DESCRIPTION OF THE PREFERRED EMBODIMENTS

### <Liquid-Repellent Properties>

It is known that roughness microstructures are formed on surfaces in order to enhance the liquid-repellent properties of the surfaces. Broadly speaking, there are two models to describe the rough surfaces.

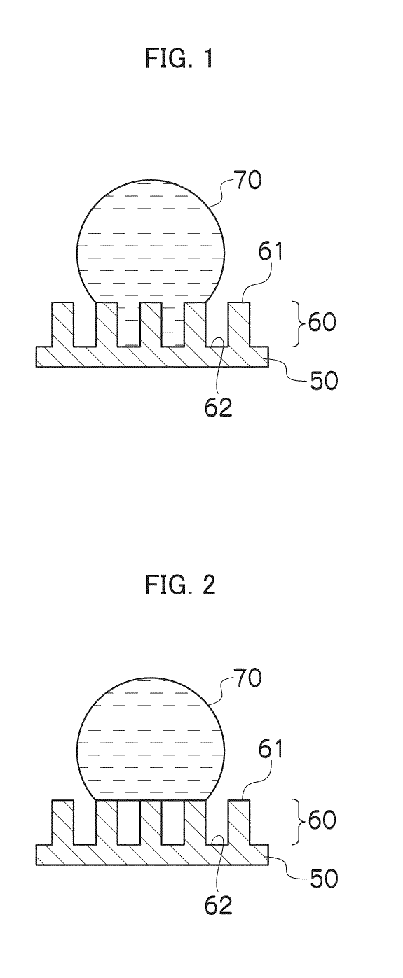

FIG. 1 shows the Wenzel model, which is one of the models and recognizes that a roughness microstructure 60 including projections 61 and recesses 62 formed on a solid 50 increases the surface area, which raises the contact angle of a liquid droplet 70. Here, the relationship between the contact angle θ of the liquid on a smooth surface of the solid given by Young's equation and the apparent contact angle θ_{w} of the liquid on the rough surface of the solid is represented as

cos θ_{w}=r·cos θ, (1)

where r is a surface area multiplication factor defined as the ratio between the surface area on the smooth surface and the surface area on the rough surface.

It is observed from Equation (1) that if the smooth surface has the repellency to the liquid or the contact angle θ is larger than 90°, the rough surface has the enhanced repellency to the liquid, whereas if the smooth surface has the affinity to the liquid or the contact angle θ is smaller than 90°, the rough surface has the enhanced affinity to the liquid. Therefore, with respect to a liquid that has the contact angle larger than 90° on the smooth surface, it is possible to realize the super-liquid-repellent surface by increasing the surface area multiplication factor by means of a fractal structure, for example; however, with respect to a liquid that has the contact angle smaller than 90° on the smooth surface, the rough surface exhibits affinity to the liquid further than the smooth surface, and the roughening of the surface is not possible to enhance the liquid-repellent properties in respect of the liquid having the low surface tension.

FIG. 2 shows the other model or the Cassie-Baxter model, which regards the liquid droplet 70 sits on a composite surface constituted of two substances having different surface tensions, i.e., the substance of the projections 61 and the other substance that fills the recesses 62. Here, the apparent contact angle θ_{c} of the liquid on the rough surface is determined on the basis of the contact angles θ₁ and θ₂ of the liquid on smooth surfaces of the two substances given by Young's equation, and is represented as

cos θ_{c}=A₁·cos θ₁+A₂·cos θ₂, (2)

where A₁ and A₂ are coefficients indicating a ratio of fractional areas of the substances in the composite surface and have the relationship of

A₁+A₂=1. (3)

In the Cassie-Baxter model, it is considered that one of the two substances is air, in other words, the roughness microstructure 60 including the projections 61 and the recesses 62 is formed on the solid 50, and the liquid droplet 70 is in contact with only the top surfaces of the projections 61, as shown in FIG. 2. Here, the contact angle θ₂ of the liquid to air is 180°, and hence the apparent contact angle θ_{c} in Expression (2) can be represented as

cos θ_{c}=A₁·cos θ₁+(1−A₁)·cos(180°). (4)

It is observed from Equation (4) that it is possible to increase the static contact angle θ_{c}, regardless of the value of θ₁, by reducing the fractional area ratio A₁ of the top surfaces of the projections 61. More specifically, it is possible to achieve high liquid-repellent properties to even the liquid of the low surface tension having the contact angle of not larger than 90° on the smooth surface, by adopting the state in which air remains trapped in the recesses 62.

There follows a description of the conditions of the roughness structure and the liquid properties in the case of the liquid of the low surface tension having the contact angle of not larger than 90° whereby, as in the Cassie-Baxter model, the liquid does not enter the recesses.

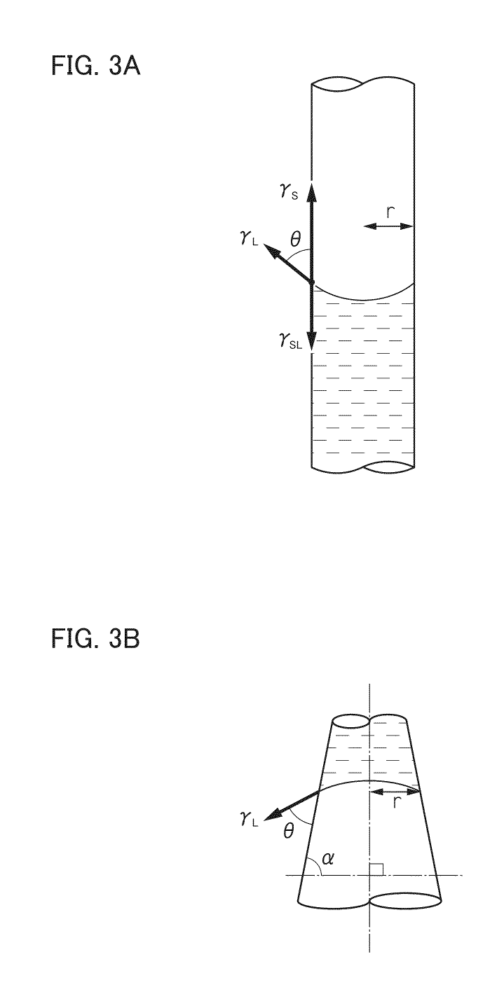

The Laplace pressure of the liquid can be used to prevent the liquid from penetrating the recesses. This is described here with reference to the capillary action. As shown in FIG. 3A, in a case of a parallel capillary, the surface of the liquid in the capillary is pulled into the capillary by the surface tension γ_{S} of the solid, and is pulled out from the capillary by the solid-liquid interface tension γ_{SL}. Then, the liquid surface receives the force obtained by multiplying the difference of these pulling tensions by the circumference of the capillary having the radius r. By dividing the received force by the cross-sectional area of the capillary, it is possible to obtain the pressure ΔP applied to the liquid surface in the capillary as

$$Δ P = \frac{2 π r ( {γ}_{S} - {γ}_{SL} )}{π {r}^{2}} . \qquad ( 5 )$$

The shape of the droplet of the liquid on the solid surface is given by Young's equation, and can be determined from the balance in the lateral direction of the surface tension γ_{L} of the liquid, the surface tension γ_{S} of the solid, and the surface tension γ_{SL} between the liquid and the solid. The pressure (capillary pressure) ΔP in Expression (5) is the pressure obtained by subtracting the pressure on the liquid side from the pressure on the air side, and can be represented by means of Young's equation as

$$Δ P = \frac{2 {γ}_{L} cos θ}{r} , \qquad ( 6 )$$

where θ is the contact angle of the liquid on the surface of the capillary.

Equation (6) means that if the contact angle θ is smaller than 90°, then the force acts on the liquid to cause the liquid to wet and spread in the capillary, and if the contact angle is larger than 90°, then the force acts on the liquid to expel the liquid from the capillary.

Expression (6) can be rewritten, by means of the Laplace equation

$$\begin{matrix}\frac{cos θ}{r} = \frac{1}{R} , \\ as & ( 7 ) \\ Δ P = \frac{2 {γ}_{L}}{R} , & ( 8 )\end{matrix}$$

where R is the radius of the droplet.

In Equation (8), ΔP represents the pressure applied to the curved surface of the liquid toward the concave side, in other words, the force which seeks to reduce the surface area of the droplet and make the droplet spherical, and the pressure ΔP is referred to as the Laplace pressure.

Next, as shown in FIG. 3B, a case is considered where a capillary is tapered with a characteristic angle α and the liquid is situated in the narrower side of the tapered capillary with respect to the liquid-air interface. The characteristic angle α of the tapered capillary is defined as an angle between the surface of the capillary and a plane perpendicular to the axis of the capillary, and the angle is taken inside the capillary on the surface of the capillary and in the narrower side of the capillary on the plane as shown in FIG. 3B. Then, Equation (6) can be written as

$$\begin{matrix}Δ P = \frac{2 {γ}_{L} cos ( θ - ( α - \frac{π}{4} ) )}{r} , \\ and & ( 9 ) \\ Δ P = \frac{- 2 {γ}_{L} sin ( θ - α )}{r} . & ( 10 )\end{matrix}$$

It is observed from Equation (10) that if θ<α, then the liquid surface assumes a concave shape and the force acts on the liquid to cause the liquid to wet and spread in the capillary due to the Laplace pressure; whereas if θ>α, then the liquid surface assumes a convex shape and the force acts on the liquid to expel the liquid from the capillary due to the Laplace pressure.

Next, the behavior of droplets on the surfaces having the roughness structures including the projections and the recesses is described.

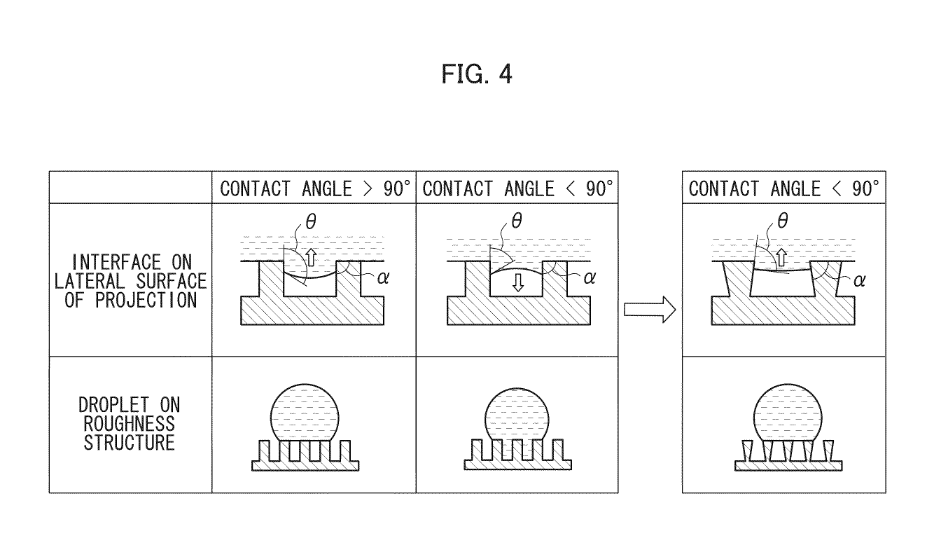

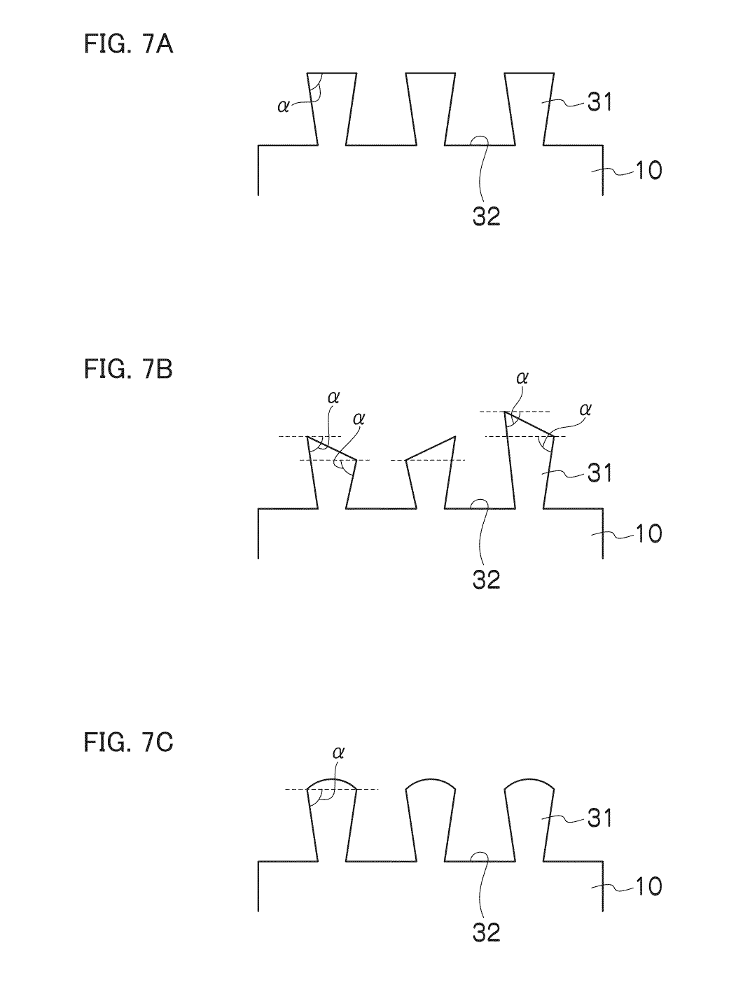

FIG. 4 shows states of the liquids entering the recesses in the roughness structures, depending on the conditions relating to the contact angles θ of the liquids on lateral surfaces of the projections, and the shapes of the projections characterized by the characteristic angles α. The characteristic angle α is defined with respect to the projection as an angle between the lateral surface of the projection and a plane that intersects with the lateral surface and is parallel to the base surface, and the angle is taken inside the projection on the lateral surface and in a side of the base surface on the plane (see also FIGS. 7A to 7C).

Firstly, cases where the projections are not tapered and have the characteristic angle α of 90° are considered. As shown in FIG. 4, if the contact angle θ of the liquid on the lateral surface of each projection is larger than 90°, the liquid surface assumes a convex shape in each recess. As described above, since the force acts on the liquid to pull the liquid to the concave side of the liquid surface due to the Laplace pressure, then the liquid does not enter the recesses. Then, if the contact angle θ is larger than 90°, the liquid can be kept out of the recesses and assume the Cassie-Baxter state.

If the contact angle θ of the liquid on the lateral surface of each projection is smaller than 90° and the characteristic angle α is 90°, then the liquid surface assumes a concave shape in each recess. In this case, since the force acts on the liquid to pull the liquid to the concave side of the liquid surface due to the Laplace pressure, then the liquid penetrates the recesses and assumes the Wenzel state. It is observed from Equation (1) in the Wenzel model, if the contact angle θ is larger than 90°, then the rough surface becomes more affinitive to the liquid.

On the other hand, in a case where the projections in the roughness structure on the surface are formed in an inverted tapered shape to have the characteristic angle α smaller than the contact angle θ of the liquid (i.e., θ>α), it is possible to cause the liquid surface to assume a convex shape in each recess, and to cause the force to act on the liquid to expel the liquid from the recesses due to the Laplace pressure. It is observed from Equations (9) and (10) that the smaller the characteristic angle α, the larger the Laplace pressure to expel the liquid from the recesses, and therefore the harder it becomes for the droplet to enter the recesses.

Conversely, if the characteristic angle α of the projections is larger than the contact angle θ of the liquid (i.e., θ<α), then the liquid surface assumes a concave shape in each recess, and the force acts on the liquid to cause the liquid to permeate the recesses, and the roughness structure exhibits affinity to the liquid in the Wenzel state.

In a case where the characteristic angle α of the projections is equal to the contact angle θ of the liquid (i.e., θ=α), since the Laplace pressure is zero and there is the equilibrium state, then the liquid remains in position, and it can be considered that the liquid-repellent properties are maintained; however, due to the weight of the droplet and energy fluctuations caused by external force, or the like, some force may act on the liquid to cause the liquid to enter the recesses. Hence, it is desirable to ensure that the Laplace pressure is applied to the liquid to expel the liquid from the recesses.

Consequently, if the projections in the roughness structure formed on the surface have the characteristic angle α of 90°, then it is possible to prevent the liquid from penetrating the recesses, with respect to the liquid that has the contact angle θ of larger than 90° on the smooth surface; however, if the liquid has the contact angle θ of smaller than 90° on the smooth surface, then the liquid penetrates the recesses, and the rough surface thereby exhibits affinity to the liquid in the Wenzel state. Therefore, the projections in the roughness structure are preferably formed in the inverted tapered shape to have the characteristic angle α smaller than the contact angle θ of the liquid on the smooth surface, and it is thereby possible to prevent the liquid from penetrating the recesses and the liquid-repellent properties can be enhanced. Furthermore, according to the Cassie-Baxter model, by reducing the fractional area ratio of the top surfaces of the projections, it is possible to enhance the liquid-repellent properties and a super-liquid-repellent surface can be formed. In the present invention, “super-liquid-repellent properties” means liquid-repellent properties exhibiting the static contact angle of not smaller than 150°.

### <Droplet Roll-Off Properties>

If a liquid droplet is deposited on a horizontal solid surface and the solid surface is gradually tilted, the droplet gradually deforms, but the position of the droplet on the solid surface does not change until the tilt angle of the solid surface reaches a certain angle. When the tilt angle reaches θ_{α}, the force pulling the droplet downward exceeds the force keeping the droplet stationary to the solid surface, and the droplet that was stationary starts to roll-off down. The tilt angle θ_{α} at which the motion of the droplet is initiated is referred to as the roll-off angle, and the relationship between the roll-off angle θ_{α} and the adhesion energy E is represented as

$$E = \frac{m g sin {θ}_{α}}{2 π r} , \qquad ( 11 )$$

where m is the mass of the deposited droplet, g is the gravitational acceleration, and r is the radius of the deposited droplet.

It is observed from Equation (11) that the roll-off angle is relative to the adhesion energy. Since the adhesion energy is the energy required to substitute the liquid adhering to the solid with air, then the adhesion energy is relative to the area of contact between the liquid and the solid surface. Consequently, in the case where the liquid droplet is adhering to the solid surface having the roughness structure, if the liquid permeates the recesses as in the Wenzel model, then the area of contact between the liquid and the solid surface increases, and therefore the adhesion energy increases and the roll-off angle also increases, which means that the droplet roll-off properties or the droplet removing properties become worse. On the other hand, by preventing the liquid from permeating the recesses and keeping air in the recesses as in the Cassie-Baxter model, it is possible to reduce the area of contact between the liquid and the solid surface, and furthermore, by reducing the ratio of the projections in the roughness structure, it is possible to further reduce the area of contact between the liquid and the solid surface, and the roll-off angle can be lowered and the droplet removing properties can be improved.

### <Method of Fabricating Roughness Structure>

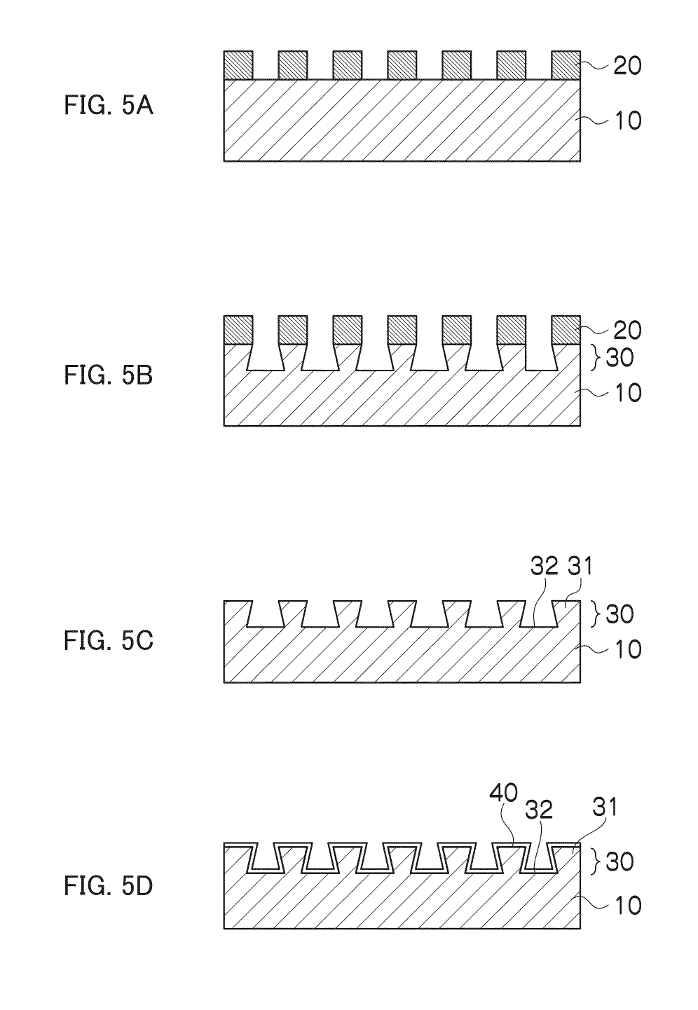

FIGS. 5A to 5D are diagrams showing a method of fabricating a roughness structure on a liquid-repellent surface according to an embodiment of the present invention.

Firstly, as shown in FIG. 5A, a mask 20 is arranged by photolithography, in portions which are to form projections of the roughness structure on a silicon substrate 10. The mask 20 can be a metal mask, such as aluminum, a resist mask, or the like.

Next, as shown in FIG. 5B, the roughness structure 30 is formed by etching in the substrate 10. In the formation of the roughness structure 30, it is possible to obtain the roughness structure of a desired shape by using a dry etching apparatus while adjusting the flow rate of sulfur hexafluoride (SF₆), which etches the silicon substrate 10, and trifluoromethane (CHF₃), which protects the lateral walls of the recesses formed in the silicon substrate 10. More specifically, the inverted tapered shapes of the projections formed by the etching can be controlled by regulating the flow rate of SF₆, which serves as an etchant for Si. CHF₃ has an effect in protecting the lateral surfaces of the etched recesses (or the lateral surfaces of the projections) from further etching, and therefore by increasing the flow rate of CHF₃, it is possible to form the projections having a large characteristic angle α. On the other hand, by increasing the flow rate of SF₆, it is possible to advance the etching on the lateral surfaces of the recesses (or the lateral surfaces of the projections), and it is possible to form the projections having a small characteristic angle α. Consequently, the characteristic angles of the inverted tapered shapes of the projections can be controlled by regulating the flow ratio of CHF₃ and SF₆.

The etching conditions can be set appropriately in accordance with the size of the roughness structure to be formed, and so on. The type of substrate and the etching method are not limited to the above-described examples, and it is also possible to use other substrates and methods.

Thereupon, as shown in FIG. 5C, the substrate 10 having the roughness structure 30 including projections 31 and recesses 32 is obtained by removing the mask material 20 by wet etching or dry etching.

Next, as shown in FIG. 5D, a liquid-repellent coating 40 is formed over the roughness structure 30 of the substrate 10. The liquid-repellent coating 40 covers the top surfaces of the projections 31, the lateral surfaces of the projections 31 (i.e., the lateral walls of the recesses 32) and the bottom surfaces of the recesses 32. It is desirable that the liquid-repellent coating 40 is formed of a material that can bond readily with the substrate 10; for example, if the substrate 10 is made of silicon, the liquid-repellent coating 40 is preferably formed of fluoroalkyl silane, which can bond with a natural oxide film on the silicon surface.

The method of forming the liquid-repellent coating can be a method of depositing fluoroalkyl silane on the substrate by vacuum vapor deposition, a method of plasma polymerizing low-molecular-weight siloxane to form a fluorine-containing plasma polymer coating or a silicon-type plasma polymer liquid-repellent coating, or the like, on the substrate, or a method of applying silane coupling agent having a carbon fluoride chain on the substrate.

The silane coupling agent is a silicon compound represented as YₙSiX₄₋ₙ(n=1, 2 or 3), where Y includes a relatively inert group, such as an alkyl group, or a reactive group, such as a vinyl group, an amino group, or an epoxy group, and X includes a group capable of bonding by condensation with a hydroxyl group or adsorption water on the substrate surface, such as a halogen, a methoxy group, an ethoxy group or an acetoxy group. The silane coupling agent is widely used in the fabrication of composite materials of an organic material and an inorganic material, such as glass fiber-reinforced plastics, in order to mediate in the bonds between the materials. If Y includes an inert group, such as an alkyl group, then adherence to or abrasion of the modified surface is prevented and characteristics such as sustained gloss, hydrophobic properties, lubricating properties, and the like, are imparted to the modified surface. If Y includes a reactive group, the agent is used principally to improve adhesiveness of the modified surface. Moreover, a surface which has been modified by means of a fluorine type silane coupling agent having a straight-chain carbon fluoride introduced into Y has low surface free energy, like the surface of PTFE (polytetrafluoroethylene), and hence the characteristics, such as hydrophobic properties, lubricating properties, mold separation, and the like, are improved, and oleophobic properties are also exhibited.

It is preferable that the material forming the liquid-repellent coating has excellent droplet roll-off properties. More specifically, it is preferable that the roll-off angle of a water droplet of 10 μl on a smooth surface of the material forming the liquid-repellent coating, which is used as the indicator of the roll-off properties, is not larger than 40°. For example, the material forming the liquid-repellent coating can be perfluoroalkyl silane containing oxygen, octadecyl silane, or the like.

The coating having the liquid-repellent properties made of a fluorine-type silane coupling agent (a chlorine, methoxy, ethoxy or isocyanate type of agent, etc.) can be formed by a dry process, such as physical epitaxy (vapor deposition, sputtering, etc.) or chemical epitaxy (chemical vapor depotision (CVD), atomic layer deposition (ALD), etc.), or a wet process, such as sol gelation, application, spin coating, or the like.

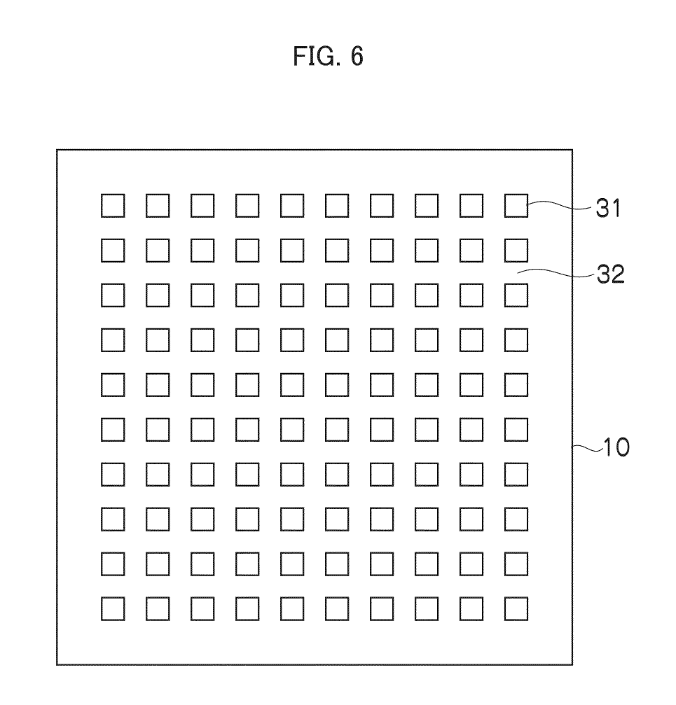

FIG. 6 is a plan diagram of the surface on which the roughness structure has been formed as described above.

The roughness structure shown in FIG. 6 includes square-shaped projections 31 arranged in a matrix. By arranging the projections 31 in the matrix, it is possible to achieve uniform distances between the projections 31, and therefore droplets can be expelled from the recesses 32 by the Laplace pressure under the same conditions. Although FIG. 6 shows the roughness structure including the square-shaped projections, the present invention is not limited to this, and it is also possible that the projections have other shapes, such as circular, triangular or octagonal shapes. Furthermore, there are no particular restrictions on the arrangement of the projections, and the projections can be arranged in a staggered matrix and do not have to be arranged regularly as shown in FIG. 6.

The projections desirably have the size of not smaller than 0.04 μm and not larger than 50 μm, and more desirably not smaller than 0.04 μm and not larger than 30 μm, in the sides of the square-shaped projections or the diameters of the circular-shaped projections, for example. The lower size limit is determined with the limit of patterning by photolithography, and at sizes below this, the fabrication costs become extremely high. The upper limit is determined because small droplets may enter recesses between projections having sizes over the upper limit. When the total area of the base surfaces of the projections 31 and the base surfaces of the recesses 32 (i.e., the area of the total base surface) is taken as 1, the ratio of the total area of the top surfaces of the projections to the area of the total base surface is desirably not more than 0.6, and more desirably, not less than 0.03 and not more than 0.4, even more desirably, not less than 0.03 and not more than 0.2. By setting the size of the projections and the fractional area ratio of the top surfaces of the projections to the ranges stated above, it is possible to make the total top surface area of the projections small with respect to the total surface area of the roughness structure, and therefore it is possible to reduce the roll-off angle as observed from Equation (11) and hence to enhance the droplet removing properties.

FIGS. 7A to 7C are cross-sectional diagrams of the roughness structures. Although there are no particular restrictions on the cross-sectional shapes of the roughness structures, it is desirable that the top surfaces of the projections 31 are parallel to the base surface of the roughness structure on the substrate 10 and the heights of the projections 31 from the base surface are all uniform as shown in FIG. 7A. In the case where the top surface of each projection is parallel to the base surface, the characteristic angle α of the projection is the angle between the lateral surface and the top surface of the projection as shown in FIG. 7A. By adopting the roughness structure shown in FIG. 7A, it is possible to achieve uniform liquid-repellent properties in the liquid-repellent surface. Moreover, since the contact area between the droplets and the roughness structure can be reduced, then it is possible to achieve good droplet roll-off properties.

FIG. 7B shows a case where the top surfaces of the projections 31 are inclined with respect to the base surface, and FIG. 7C shows a case where the top surfaces of the projections 31 are curved. As shown in FIGS. 7B and 7C, in the case where the top surface of each projection is not parallel to the base surface, the characteristic angle α of the projection is the angle between the lateral surface of the projection and the plane that intersects with the lateral surface and is parallel to the base surface, and the angle is taken inside the projection on the lateral surface and in the side of the base surface on the plane.

The shapes of the projections 31 are adjusted to have the prescribed characteristic angles α smaller than the static contact angle θ of the liquid on the smooth surface. By making the shape of each projection in the range of 20% from the top of the projection to have the appropriate characteristic angle α, it is possible to cause the Laplace pressure to expel the liquid that seeks to enter the recesses. It is more preferable that, taking account of the cleaning properties described below, the shape of the projections is made to have the appropriate characteristic angle α over the whole of the lateral faces of the projections, so that it is possible for a cleaning liquid and a substituting liquid that substitutes the cleaning liquid, to be applied in the recesses and then expelled from the recesses.

### <Cleaning Properties>

The liquid droplets which are smaller than the width of the recesses in the roughness structure and the liquid droplets which are not smaller than the width of the recesses but are applied with the gravitational force or other external force greater than the Laplace pressure, may enter the recesses regardless of the static contact angle of the liquid on the smooth surface, and then the super-liquid-repellent properties of the roughness structure cannot readily be maintained over a long period of time. In particular, when the liquid-repellent surface provided with the roughness structure is used on a nozzle plate of an inkjet head, since ink mist is liable to enter the recesses, then decline in the liquid-repellent properties of the nozzle plate is observed. Hence, the roughness structure is required to have cleaning properties or capability of being restored to the original state by cleaning the roughness structure to expel the liquid having entered the recesses.

The cleaning properties are achieved by utilizing the Laplace pressure in the above-described tapered structure to expel the liquid from the recesses. It is observed from Equation (10) that, as θ becomes closer to α, so the force seeking to expel the liquid from the recesses of the roughness structure becomes smaller and hence the liquid becomes more liable to remain inside the recesses.

Therefore, firstly, the soiling inside the recesses of the roughness structure is removed with the cleaning liquid having the static contact angle on the smooth surface that is smaller than the characteristic angle of the projections. By using the cleaning liquid of this kind, it is possible to cause the Laplace pressure to act on the cleaning liquid to cause the cleaning liquid to penetrate the recesses, and the insides of the recesses can be cleaned readily with the cleaning liquid.

Thereupon, the substituting liquid having the large surface tension is applied to the roughness structure, and the cleaning liquid inside the recesses is replaced by the substituting liquid. Since the substituting liquid of the large surface tension also has the large contact angle, then it is possible to cause the Laplace pressure to act on the substituting liquid inside the recesses to expel the substituting liquid from the recesses. Consequently, the substituting liquid having substituted the cleaning liquid inside the recesses can be expelled from the recesses, and therefore it is possible to remove the liquids readily.

### Nozzle Plate of Inkjet Head

Next, the nozzle plate of the inkjet head that employs the structure body having the liquid-repellent surface according to an embodiment of the present invention is described.

### <General Composition of Inkjet Recording Apparatus>

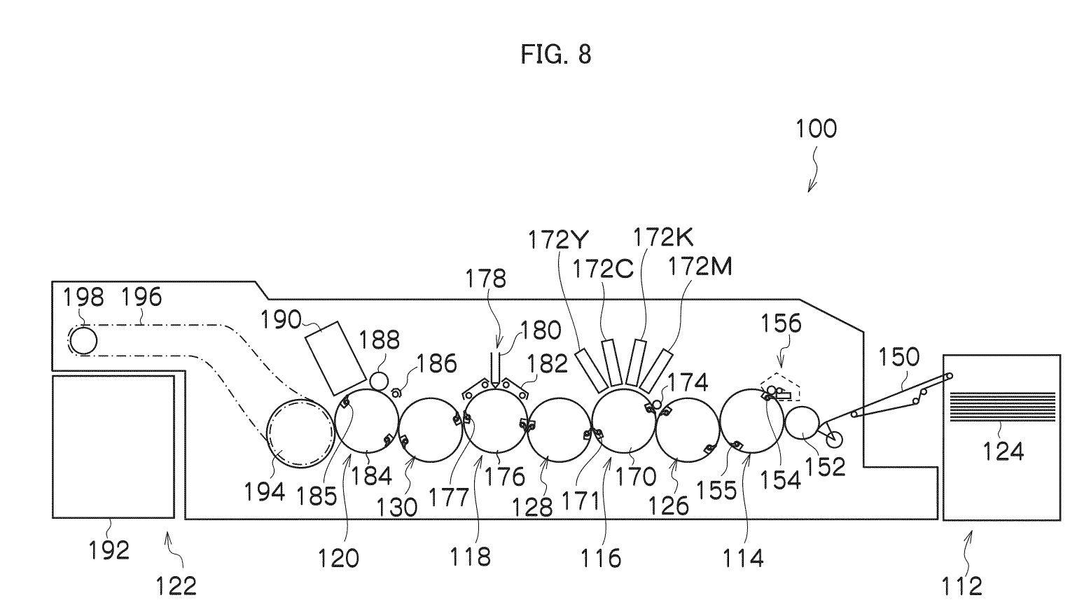

Firstly, an inkjet recording apparatus is described. FIG. 8 is a schematic drawing of the inkjet recording apparatus 100 equipped with the inkjet heads. The inkjet recording apparatus 100 employs a pressure drum direct image formation method, which forms a desired color image by ejecting and depositing droplets of inks of a plurality of colors (for example, magenta (M), black (K), cyan (C) and yellow (Y)) from the inkjet heads 172M, 172K, 172C and 172Y onto a recording medium 124 (hereinafter referred also to as “paper” for the sake of convenience) held on a pressure drum (image formation drum) 170 in an image formation unit 116. The inkjet recording apparatus 100 is an image forming apparatus of an on-demand type employing a two-liquid reaction (aggregation) method in which the image is formed on the recording medium 124 by depositing a treatment liquid (here, an aggregating treatment liquid) on the recording medium 124 before depositing the droplets of ink, and causing the treatment liquid and the ink liquid to react together.

As shown in FIG. 8, the inkjet recording apparatus 100 includes a paper feed unit 112, a treatment liquid deposition unit 114, the image formation unit 116, a drying unit 118, a fixing unit 120 and a paper output unit 122.

### <<Paper Supply Unit>>

The paper supply unit 112 is a mechanism for supplying the recording medium 124 to the treatment liquid deposition unit 114, and the recording media 124, which can be cut sheets of paper, are stacked in the paper supply unit 112. A paper supply tray 150 is arranged in the paper supply unit 112, and the recording medium 124 is supplied one sheet at a time to the treatment liquid deposition unit 114 from the paper supply tray 150.

### <<Treatment Liquid Deposition Unit>>

The treatment liquid deposition unit 114 is a mechanism for depositing the treatment liquid onto a recording surface of the recording medium 124. The treatment liquid includes a coloring material aggregating agent, which aggregates the coloring material (in the present embodiment, the pigment) in the ink deposited by the image formation unit 116, and the separation of the ink into the coloring material and the solvent is promoted due to the treatment liquid and the ink making contact with each other.

As shown in FIG. 8, the treatment liquid deposition unit 114 includes a paper supply drum 152, a treatment liquid drum 154 and a treatment liquid application device 156. The treatment liquid drum 154 holds and conveys the recording medium 124 so as to rotate. The treatment liquid drum 154 has a hook-shaped holding device (gripper) 155 arranged on the outer circumferential surface thereof, and is configured to hold the leading end of the recording medium 124 by gripping the recording medium 124 between the hook of the gripper 155 and the circumferential surface of the treatment liquid drum 154.

The treatment liquid application device 156 is arranged to face the circumferential surface of the treatment liquid drum 154. The treatment liquid application device 156 includes: a treatment liquid vessel, in which the treatment liquid is stored; an anilox roller, which is partially immersed in the treatment liquid in the treatment liquid vessel; and a rubber roller, which transfers a dosed amount of the treatment liquid to the recording medium 124, by being pressed against the anilox roller and the recording medium 124 on the treatment liquid drum 154. The treatment liquid application device 156 can apply the treatment liquid to the recording medium 124 while dosing the amount of the treatment liquid.

The recording medium 124 onto which the treatment liquid has been deposited in the treatment liquid deposition unit 114 is transferred from the treatment liquid drum 154 to the image formation drum 170 of the image formation unit 116 through an intermediate conveyance unit 126.

### <<Image Formation Unit>>

The image formation unit 116 includes an image formation drum 170, a paper pressing roller 174, and the inkjet heads 172M, 172K, 172C and 172Y. Similarly to the treatment liquid drum 154, the image formation drum 170 has a hook-shaped holding device (gripper) 171 on the outer circumferential surface thereof. The recording medium 124 held on the image formation drum 170 is conveyed with the recording surface thereof facing to the outer side, and the inks are deposited onto the recording surface from the inkjet heads 172M, 172K, 172C and 172Y.

It is desirable that the inkjet heads 172M, 172K, 172C and 172Y are full-line type inkjet recording heads (inkjet heads) having a length corresponding to the maximum width of the image forming region on the recording medium 124. A row of nozzles for ejecting droplets of the ink arranged over the whole width of the image forming region is formed in the ink ejection surface of each of the inkjet heads 172M, 172K, 172C and 172Y. The inkjet heads 172M, 172K, 172Y and 172Y are disposed so as to extend in a direction perpendicular to the conveyance direction of the recording medium 124 (the direction of rotation of the image formation drum 170).

When droplets of the corresponding colored ink are ejected and deposited from each of the inkjet heads 172M, 172K, 172C and 172Y to the recording surface of the recording medium 124, which is held tightly on the image formation drum 170, the deposited ink makes contact with the treatment liquid, which has previously been deposited on the recording surface by the treatment liquid deposition unit 114, the coloring material (pigment) dispersed in the ink is aggregated, and a coloring material aggregate is thereby formed. Thereby, flowing of the coloring material, and the like, on the recording medium 124 is prevented and an image is formed on the recording surface of the recording medium 124.

The recording medium 124 onto which the image has been formed in the image formation unit 116 is transferred from the image formation drum 170 to a drying drum 176 of the drying unit 118 through an intermediate conveyance unit 128.

### <<Drying Unit>>

The drying unit 118 is a mechanism for drying the solvent which has been separated by the action of aggregating the coloring material, and as shown in FIG. 8, includes the drying drum 176 and a solvent drying device 178.

Similarly to the treatment liquid drum 154, the drying drum 176 has a hook-shaped holding device (gripper) 177 arranged on the outer circumferential surface thereof, in such a manner that the leading end of the recording medium 124 can be held by the holding device 177.

The solvent drying device 178 is arranged to face the outer circumferential surface of the drying drum 176, and includes a plurality of halogen heaters 182 and a hot air spraying nozzle 180 disposed between the heaters 182.

The recording medium 124 on which a drying process has been carried out in the drying unit 118 is transferred from the drying drum 176 to a fixing drum 184 of the fixing unit 120 through an intermediate conveyance unit 130.

### <<Fixing Unit>>

The fixing unit 120 includes the fixing drum 184, a halogen heater 186, a fixing roller 188 and an in-line sensor 190. Similarly to the treatment liquid drum 154, the fixing drum 184 has a hook-shaped holding device (gripper) 185 arranged on the outer circumferential surface thereof, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 are carried out in respect of the recording surface.

In the fixing unit 120, thermoplastic resin particles in the thin image layer formed by the drying unit 118 are heated, pressed and melted by the fixing roller 188, and thereby the image layer can be fixed to the recording medium 124. By setting the surface temperature of the fixing drum 184 to not lower than 50° C., drying is promoted by heating the recording medium 124 held on the outer circumferential surface of the fixing drum 184 from the rear surface, and therefore breaking of the image during the fixing process can be prevented, and furthermore, the strength of the image can be increased by the effects of the increased temperature of the image.

In cases where an ultraviolet-curable monomer is contained in the inks, after the solvent has been evaporated off sufficiently in the drying unit, the image is irradiated with ultraviolet light in the fixing unit including an ultraviolet irradiation lamp, and it is thereby possible to cure and polymerize the ultraviolet-curable monomer and improve the strength of the image.

### <<Paper Output Unit>>

As shown in FIG. 8, the paper output unit 122 is arranged subsequently to the fixing unit 120. The paper output unit 122 includes an output tray 192, and a transfer drum 194, a conveyance belt 196 and a tensioning roller 198 arranged between the output tray 192 and the fixing drum 184 of the fixing unit 120 so as to oppose same. The recording medium 124 is sent to the conveyance belt 196 by the transfer drum 194 and output to the output tray 192.

Furthermore, although not shown in FIG. 8, the inkjet recording apparatus 100 in the present embodiment includes, in addition to the composition described above, an ink storing and loading unit, which supplies the inks to the inkjet heads 172M, 172K, 172C and 172Y, and a device which supplies the treatment liquid to the treatment liquid deposition unit 114, as well as including a head maintenance unit, which carries out cleaning (nozzle surface wiping, purging, nozzle suction, and the like) of the inkjet heads 172M, 172K, 172C and 172Y, a position determination sensor, which determines the position of the recording medium 124 in the paper conveyance path, a temperature sensor, which determines the temperature of the respective units of the apparatus, and the like.

Although the inkjet recording apparatus based on the drum conveyance system is described with reference to FIG. 8, the present invention is not limited to this and can also be used in an inkjet recording apparatus based on a belt conveyance system, or the like.

### <Structure of Inkjet Head>

Next, the structure of the inkjet heads 172M, 172K, 172C and 172Y is described. Here, the respective inkjet heads 172M, 172K, 172C and 172Y have the same structure, and any of the heads is hereinafter denoted with a reference numeral 250 and described.

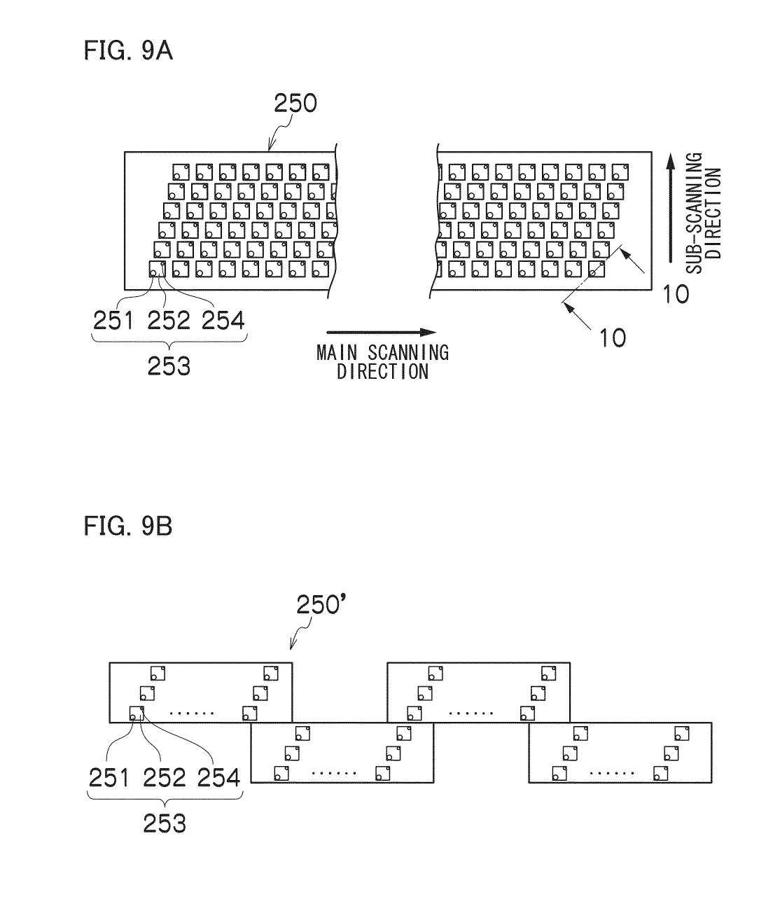

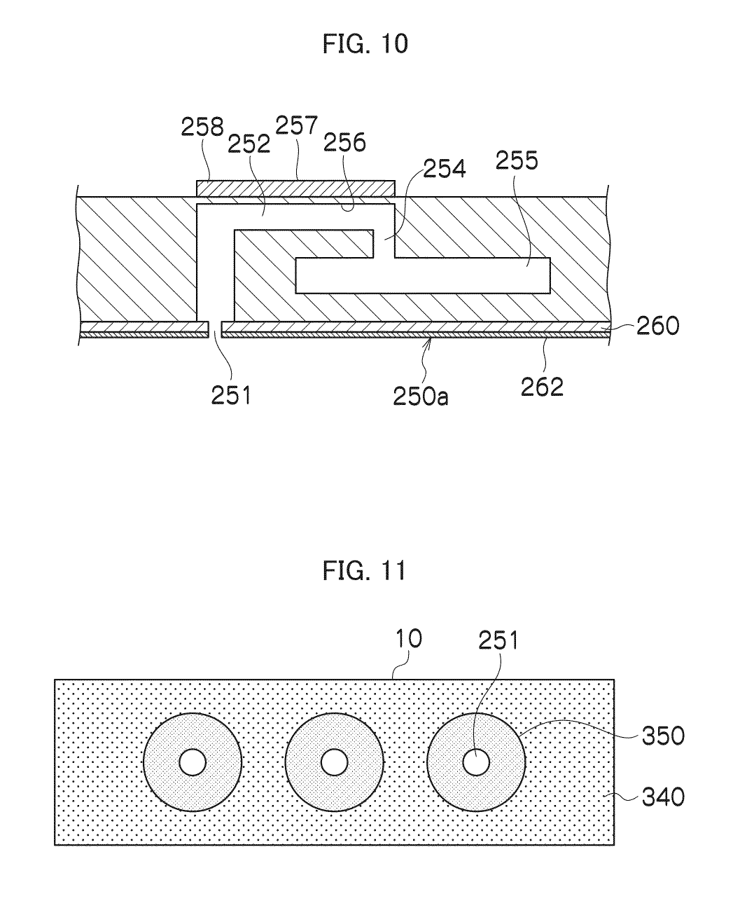

FIG. 9A is a plan view perspective drawing showing an example of a structure of the inkjet head 250, and FIG. 9B is a plan view perspective drawing showing another example of a structure of the inkjet head 250. FIG. 10 is a cross-sectional diagram taken along line 10-10 in FIG. 9A and shows the inner structure of an ink chamber unit.

In order to achieve a high density of the dots formed with the ink droplets on the surface of the recording paper, it is necessary to achieve a high density of the nozzles by reducing the nozzle pitch in the inkjet head 250. As shown in FIG. 9A, the inkjet head 250 in the present embodiment has a structure in which a plurality of ink chamber units 253 are arranged in a staggered matrix configuration (two-dimensional configuration). Each of the ink chamber units 253 includes a nozzle 251 serving as an ink droplet ejection aperture, a pressure chamber 252 corresponding to the nozzle 251, and the like. Accordingly, the high density of the nozzles is achieved by reducing the effective nozzle pitch or the projected nozzle pitch projected to an alignment in the lengthwise direction of the inkjet head 250 along the main scanning direction, which is perpendicular to the sub-scanning direction or the paper conveyance direction.

The arrangement of one or more nozzle rows covering the length corresponding to the full width of the recording medium 124 in the direction substantially perpendicular to the paper conveyance direction is not limited to the arrangement shown in FIG. 9A. For example, instead of the composition in FIG. 9A, a line head having nozzle rows of the length corresponding to the entire width of the recording medium 124 can be formed by arranging and combining, in a staggered matrix, short head blocks (head chips) 250′ each having the nozzles 251 arrayed two-dimensionally, as shown in FIG. 9B. Furthermore, although not shown in the drawings, it is also possible to form a line head by aligning short heads in a single row.

As shown in FIG. 10, each of the nozzles 251 is formed in a nozzle plate 260, which constitutes an ink ejection surface 250a of the inkjet head 250. The nozzle plate 260 can be made of a silicon material, such as Si, SiO₂, SiN or quartz glass, a metal material such as Al, Fe, Ni, Cu or an alloy of these, an oxide material such as alumina or iron oxide, a carbonaceous material such as carbon black or graphite, or a resin material such as polyimide.

A liquid-repellent coating 262 having repellent properties with respect to the ink is formed on the surface (ink ejection side surface) of the nozzle plate 260, to prevent adherence of the ink on the ink ejection surface. Each of the pressure chambers 252, which are provided correspondingly to the nozzles 251, is formed with a substantially square planar shape, and the nozzle 251 and a supply port 254 are arranged in the respective corner portions on a diagonal of this planar shape. The respective pressure chambers 252 connect with a common flow channel 255 through the supply ports 254. The common flow channel 255 is connected to an ink supply tank (not shown) serving as an ink supply source, and the ink supplied from the ink supply tank is distributed through the common flow channel 255 to the pressure chambers 252.

Piezoelectric elements 258 each having individual electrodes 257 are bonded to the diaphragm 256, which constitutes ceiling faces of the pressure chambers 252 and also serves as a common electrode for the piezoelectric elements 258. Each piezoelectric element 258 is deformed by applying a drive voltage to the individual electrode 257, thereby causing the ink in the corresponding pressure chamber 252 to be ejected from the nozzle 251. When the ink is ejected, new ink is supplied to the pressure chamber 252 from the common flow channel 255 through the supply port 254.

The arrangement structure of the nozzles is not limited to the examples shown in the drawings, and it is also possible to apply various other types of nozzle arrangements, such as an arrangement structure having a single nozzle row in the sub-scanning direction.

The print method is not limited to using the line type heads, and can be a serial method in which printing is performed in the widthwise direction of the recording medium 124 (the main scanning direction) by employing a short head that is shorter than the dimension of the recording medium 124 in the widthwise direction and performing a scanning action of the short head in the widthwise direction, and after completing one printing action in the widthwise direction, the recording medium 124 is moved by a prescribed amount in the sub-scanning direction perpendicular to the widthwise direction, printing in the widthwise direction of the recording medium 124 is performed on the next print region, and by repeating this operation, printing is performed over the whole of the printing area of the recording medium 124.

FIG. 11 is a diagram showing the ink ejection surface of the nozzle plate of the inkjet head in the present embodiment. As shown in FIG. 11, the ink ejection surface of the nozzle plate includes first liquid-repellent regions 350 around the nozzles 251, and a second liquid-repellent region 340 around the first liquid-repellent regions 350. In each of the first liquid-repellent regions 350, the liquid-repellent coating is formed on the smooth surface of the substrate 10 without the roughness structure. In the second liquid-repellent region 340, the surface of the substrate 10 has the roughness structure according to the embodiment of the present invention.

By arranging the smooth liquid-repellent region without the roughness structure about the periphery of the nozzle, the following beneficial effects are obtained in comparison with a case where the smooth liquid-repellent region is not arranged and the nozzle is directly surrounded by the surface having the roughness structure.

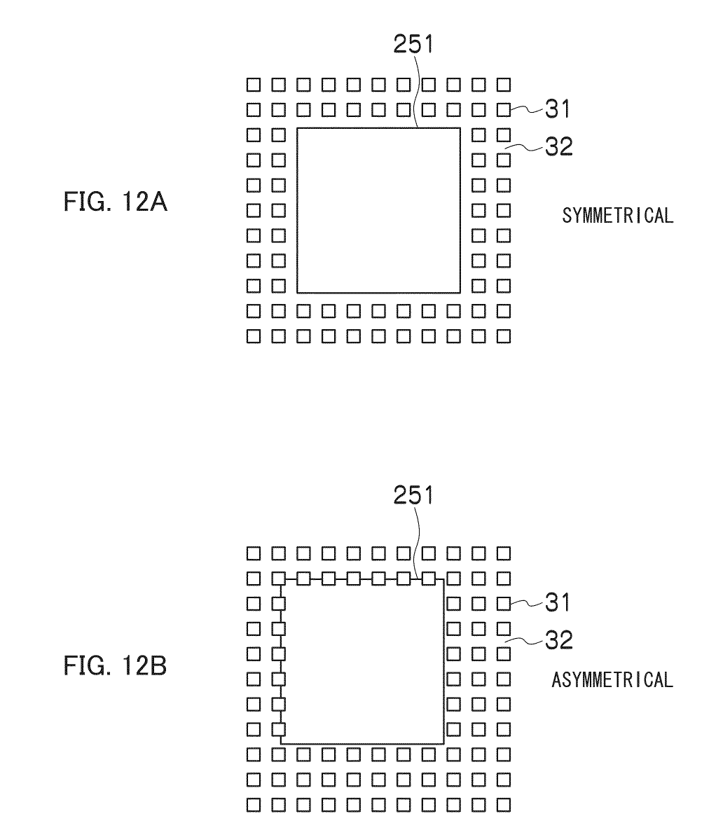

FIGS. 12A and 12B are diagrams of the cases where the smooth liquid-repellent regions are not arranged about the peripheries of the nozzles 251. FIG. 12A shows the case where the roughness structure including the projections 31 and the recesses 32 is formed symmetrically in the vertical and lateral directions in the drawing with respect to the nozzle 251, and FIG. 12B shows the case where the roughness structure is formed asymmetrically with respect to the nozzle 251.

In the cases where the roughness structure is arranged without the smooth region about the periphery of the nozzle 251, if the roughness structure is arranged symmetrically in the vertical and lateral directions with respect to the nozzle 251 as shown in FIG. 12A, there is no deflection of the ejection direction to any side when droplets are ejected from the nozzle 251. However, as shown in FIG. 12B, if there is deviation in the position where the nozzle 251 is arranged and the projections 31 and the recesses 32 in the roughness structure arranged on the nozzle plate overlap with the nozzle 251, then the nozzle 251 becomes asymmetrical, giving rise to deflection of the ejection direction. The alignment accuracy when fabricating the nozzles 251 and the roughness structure can be in the range of 1 μm to 2 μm. Hence, the nozzles 251 and the roughness structure cannot not be formed with high accuracy, and there is a possibility that the roughness structure is asymmetrical in the vertical and lateral directions with respect to each nozzle.

Consequently, as shown in FIG. 11, it is desirable that the first liquid-repellent regions 350, which have the smooth surfaces without the roughness structure, are arranged about the peripheries of the nozzles 251, and the second liquid-repellent region 340 having the surface with the roughness structure is arranged about the periphery of the first liquid-repellent regions 350. By forming the smooth liquid-repellent regions 350 about the peripheries of the nozzles 251, it is possible to prevent deflections of the ink droplet ejections performed through the nozzles 251. The second liquid-repellent region 340 is preferably separated from each nozzle 251 by a distance of not smaller than 10 μm and not larger than 50 μm.

In order to form the nozzle plate surface of this kind in the fabrication of the nozzle plate, the regions on the base surface of the substrate that are to become the first liquid-repellent regions 350 are covered with a mask when forming the roughness structure on the base surface. Thereby, the roughness structure is not formed in the regions that are to become the first liquid-repellent regions 350, and it is possible to form the smooth liquid-repellent regions provided with the liquid-repellent coating.

### PRACTICAL EXAMPLES

Below, the present invention is described more specifically with reference to practical examples. Processing methods described in the practical examples can involve a method of processing a substrate surface having liquid-repellent properties to form the projections of the inverted tapered shape thereon, or a method of processing a substrate surface to form the projections of the inverted tapered shape thereon and then form the liquid-repellent coating thereon. The processing methods are not limited to these exemplary methods.

### <Fabrication of Roughness Structures>

Using metal film masks patterned with resist, dry etching was carried out on surfaces of silicon substrates under the conditions in Samples A and B described below, so that the projections having the inverted tapered shapes were formed thereon. It is also possible to use patterned resist films as the masks.

### <<Etching Conditions>>

Etching apparatus: NE500-ICP dry etching apparatus (Ulvac Techno)
Etching conditions in Sample A (formed with the projections having the characteristic angle of 100°): processing pressure: 1 Pa; antenna output: 400 W; bias output: 70 W; processing gases: CHF₃ of 50 sccm and SF₆ of 5 sccm; processing time: 1200 sec.
Etching conditions in Sample B (formed with the projections having the characteristic angle of 75°): processing pressure: 1 Pa; antenna output: 500 W; bias output: 100 W; processing gases: CHF₃ of 30 sccm and SF₆ of 20 sccm; processing time: 480 sec.

Thereupon, the masks were removed by wet etching and then liquid-repellent coatings of Nanos (T&K Co., Ltd.) were formed by vacuum vapor deposition on the obtained roughness structures. Although there are no particular restrictions on the liquid-repellent coating, it is preferably a coating having excellent droplet roll-off properties. Furthermore, the formation method of the coatings is not limited to the vapor deposition method, and it is also possible to employ a spin coating method, or the like. The roll-off angle of a 10 μl water droplet on the smooth surface of the thus formed liquid-repellent coating was 10°.

The length of a side in the square shape of the projections of the obtained roughness structures was approximately 5 μm and the distance between the projections (the width of the recesses) was approximately 5 μm. The factional area of the top surfaces of the projections was around 30%.

The following liquids were placed in contact with the liquid-repellent surfaces having the roughness structures thus formed on the substrates, and the apparent static contact angles and the roll-off angles were measured. The surface tensions of the liquids were adjusted by the amounts of added olefin to control the static contact angles of the liquids on the smooth surface.

### <<Liquids Used>>

(1) Water (surface tension of 72.75 mN/m, static contact angle of 116° on smooth surface) 4 μl
(2) Water+olefin 0.1% (surface tension of 40.0 mN/m, static contact angle of 96° on smooth surface) 4 μl
(3) Water+olefin 0.5% (surface tension of 35.2 mN/m, static contact angle of 86° on smooth surface) 4 μl
(4) Water+olefin 1% (surface tension of 28 mN/m, static contact angle of 71° on smooth surface) 4 μl

The results are shown in Table 1 below.

TABLE 1

| | | | Liquid | Liquid | Liquid | Liquid |
|---|---|---|---|---|---|---|
| | Sample | Evaluation item | (1) | (2) | (3) | (4) |
| Comparative | A: Characteristic | Apparent static contact angle | 156° | 141° | 130° | 80° |
| Example | angle of 100° | Roll-off angle | 18° | — | — | — |
| Practical | B: Characteristic | Apparent static contact angle | 155° | 154° | 151° | 135° |
| Example | angle of 75° | Roll-off angle | 36° | 33° | 32° | — |

In Sample B (Practical Example) where the roughness structure was formed with the projections of the inverted tapered shape having the characteristic angle of 75°, the obtained liquid-repellent surface exhibited the apparent static contact angles larger than 150° and allowed the droplets to roll off, with respect to the liquids (1), (2) and (3), which had the static contact angles on the smooth surface larger than the characteristic angle of the projections. In particular, with respect to even the liquid (3) having the static contact angle of not larger than 90° on the smooth surface, the obtained liquid-repellent surface exhibited high liquid-repellent properties with the apparent static contact angle of 151° and also high droplet roll-off properties with the roll-off angle of 32°.

With respect to the liquid (4), which had the static contact angle on the smooth surface smaller than the characteristic angle of the projections, the obtained liquid-repellent surface exhibited high liquid-repellent properties with the apparent static contact angle of 135°, but did not allow the droplets to roll off even when the liquid-repellent surface was tilted by 90°. This is thought to be because the liquid penetrated the recesses of the roughness structure and the adhesion energy was high.

In Sample A (Comparative Example) where the roughness structure was formed with the projections of the tapered shape having the characteristic angle of 100°, the obtained liquid-repellent surface exhibited high liquid-repellent properties (large apparent static contact angle) and high droplet roll-off properties (small roll-off angle), with respect to the liquid (1), which had the static contact angle on the smooth surface larger than the characteristic angle of the projections. However, with respect to the liquids (2), (3) and (4), which had the static contact angles on the smooth surface smaller than the characteristic angle of the projections, the liquids are thought to have penetrated the recesses of the roughness structure, and although high liquid-repellent properties were obtained with the liquids (2) and (3), the droplets of the liquids did not roll off.

### <<Evaluation of Cleaning Properties>>

The cleaning properties were evaluated by using the liquid-repellent surface (practical example) on which the roughness structure was formed with the projections of the inverted tapered shape having the characteristic angle of 75° fabricated under the conditions in Sample B, and a smooth surface (comparative example).

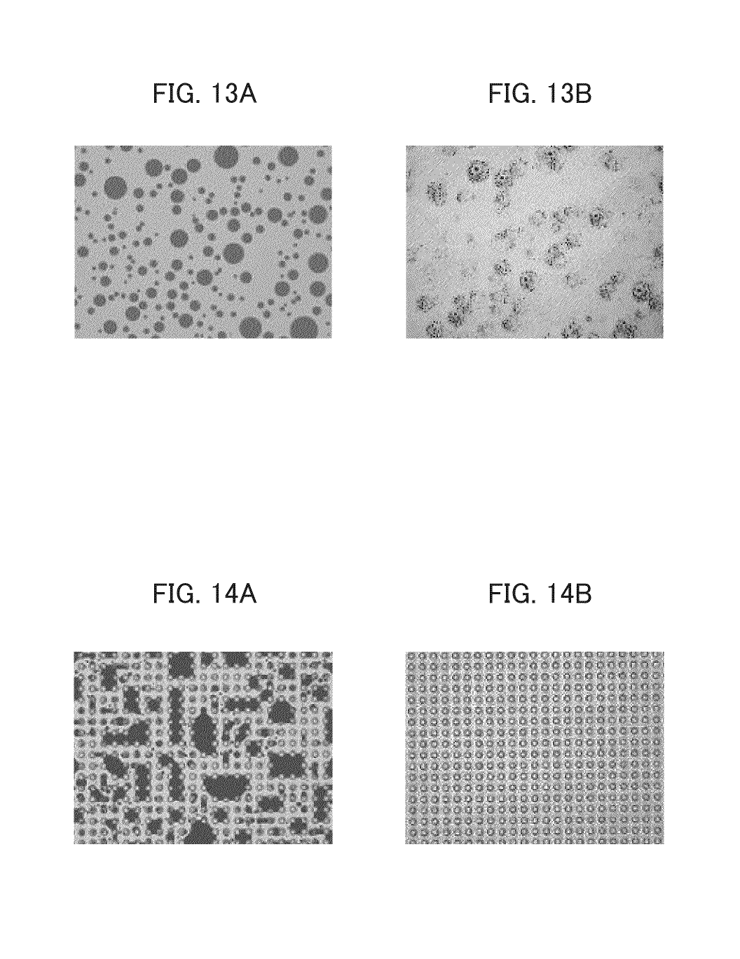

Ink droplets having diameters of 1 μm to 50 μm were deposited onto the surfaces of the substrates, and were left to dry for 1 hour. Thereafter, a cleaning liquid (surface tension of 28 mN/m, static contact angle of 70° on smooth surface) was sprayed to the surfaces of the substrates for 5 seconds at a rate of 0.9 liter/minute and was then rinsed away with pure water. Then, residues on the surfaces of the substrates were observed and evaluated. FIGS. 13A and 13B show results for the comparative example of the smooth surface, and FIGS. 14A and 14B show results for the practical example of the liquid-repellent surface having the roughness structure. FIGS. 13A and 14A show pre-cleaning states, and FIGS. 13B and 14B show post-cleaning states.

The ink residue was observed on the smooth surface after the cleaning (FIG. 13B), whereas no ink residue was observed on the liquid-repellent surface having the roughness structure after the cleaning (FIG. 14B), and high cleaning properties were confirmed. Furthermore, it was confirmed that the liquid-repellent surface having the roughness structure after the cleaning exhibited the liquid-repellent properties and the droplet roll-off properties which were the same as before depositing the ink.

A summary of the above-described Examples is given in Table 2 below. The evaluations were made with respect to the liquid having the static contact angle of not larger than 90° on the smooth surface.

TABLE 2

| | Liquid-repellent | Roll-off | Cleaning |
|---|---|---|---|
| | properties | properties | properties |
| Smooth surface | Poor | Good | Poor |
| Sample A | Good | Poor | — |
| Sample B | Good | Good | Good |

As shown in Table 2, in the smooth surface, good results were obtained for the droplet roll-off properties (the droplet roll-off angle), but the liquid-repellent properties (the apparent static contact angle) and the cleaning properties were poor. In Sample A where the roughness structure was formed with the projections of the tapered shape having the characteristic angle of larger than 90°, good results were obtained for the liquid-repellent properties, but since the liquid penetrated the recesses in the roughness structure, the roll-off properties were poor. On the other hand, in Sample B where the roughness structure was formed with the projections of the inverted tapered shape having the characteristic angle of smaller than 90°, good results were obtained for the liquid-repellent properties, the roll-off properties and the cleaning properties.

### <<Ratio of Area of Projections>>

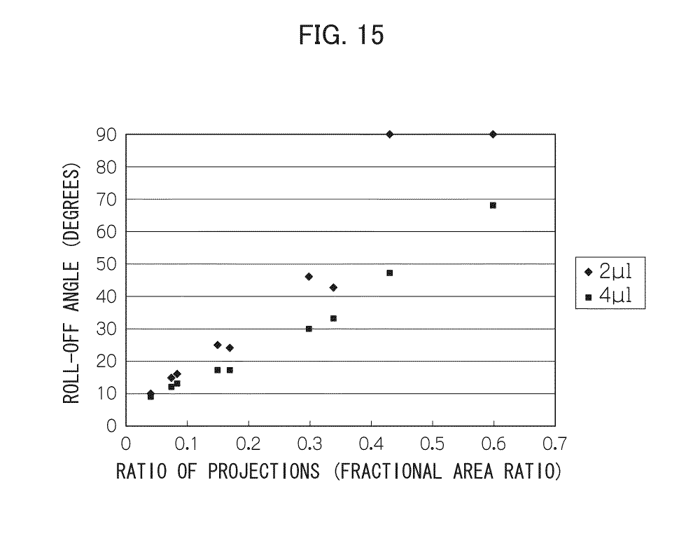

Evaluations based on the roll-off angles on the liquid-repellent surfaces were carried out by setting the shape of the projections in the roughness structures to the shape of Sample B (characteristic angle of 75°) and altering the ratio of the total area of the top surfaces of the projections to the area of the total base surface in the roughness structures. The projections were a square shape with sides of 5 μm. Droplets of 2 μl and 4 μl of the above-described liquid (3) (water+olefin 0.5% (surface tension of 35.2 mN/m, static contact angle of 86° on smooth surface)) were deposited onto the liquid-repellent surfaces having the roughness structure, and the roll-off angles were measured. The results are shown in FIG. 15.

The plots on the 90° roll-off angle line indicate that the droplets did not roll off, even when the liquid-repellent surfaces were tilted by 90°. According to FIG. 15, it is possible to reduce the droplet roll-off angle by reducing the fractional area ratio of the top surfaces of the projections. Furthermore, it is also confirmed that by making the fractional area ratio of the top surfaces of the projections not higher than 0.4, even small droplets of 2 μl rolled off the liquid-repellent surface. The apparent static contact angles on the liquid-repellent surfaces having the roughness structures were not smaller than 140°, regardless of the fractional area ratios of the top surfaces of the projections and the droplet sizes, and good liquid-repellent properties were obtained.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A structure body having a liquid-repellent surface exhibiting repellency to a liquid, the structure body comprising:
a substrate which has a base surface; and
a plurality of projections which are arranged on the base surface of the substrate, wherein:
the projections have a characteristic angle defined as an angle between a lateral surface of each of the projections and a plane that intersects with the lateral surface and is parallel to the base surface, the angle being taken inside the projection on the lateral surface and in a side of the base surface on the plane; and
the characteristic angle of the projections is smaller than 90° and is smaller than a reference angle that is separately determined as a static contact angle of the liquid with respect to a reference surface that is smooth and has a chemical state identical to a chemical state of the lateral surface of each of the projections.

2. The structure body as defined in claim 1, wherein the projections have top surfaces which are parallel to the base surface and have a uniform height from the base surface.

3. The structure body as defined in claim 1, wherein a ratio of a total area of top surfaces of the projections with respect to a total area of the base surface is not higher than 0.4.

4. The structure body as defined in claim 1, further comprising a liquid-repellent coating which covers the base surface and the projections.

5. The structure body as defined in claim 4, wherein a roll-off angle of a 10 μl water droplet on the liquid-repellent coating is not larger than 40°.

6. The structure body as defined in claim 4, wherein the liquid-repellent coating is composed of perfluoroalkyl silane containing oxygen.

7. A method of cleaning the structure body as defined in claim 1, the method comprising the steps of:
cleaning the structure body with a cleaning liquid having a static contact angle with respect to the reference surface that is smaller than the characteristic angle of the projections; and
then substituting the cleaning liquid remaining on the structure body with a substituting liquid having a static contact angle with respect to the reference surface that is larger than the characteristic angle of the projections.

8. A nozzle plate of an inkjet head comprising the structure body as defined in claim 1.

9. The nozzle plate as defined in claim 8, wherein the projections are arranged only in regions distanced from nozzles by at least 10 μm.

10. A method of cleaning the nozzle plate as defined in claim 8, the method comprising the steps of:
cleaning the nozzle plate with a cleaning liquid having a static contact angle with respect to the reference surface that is smaller than the characteristic angle of the projections; and
then substituting the cleaning liquid remaining on the nozzle plate with a substituting liquid having a static contact angle with respect to the reference surface that is larger than the characteristic angle of the projections.
